(19) United States
(12) Patent Application Publication
(10) Pub. No.: US 2005/0009585 A1
(43) Pub. Date: Jan. 13, 2005

(54) Hidden planar antenna module for mobile phone

(75) Inventor: I-Fong Chen, Tao-Yuan City (TW)

Correspondence Address: BRUCE H. TROXELL, SUITE 1404, 5205 LEESBURG PIKE, FALLS CHURCH, VA, 22041, US

(73) Assignee: AUDEN TECHNO CORP.

(21) Appl. No.: 10/617,018

(22) Filed: Jul. 11, 2003

(51) Int. Cl. H04M 1/00; H04B 1/38

(52) U.S. Cl. 455/575.7; 455/575.1

(57) ABSTRACT

A hidden planar antenna module for a mobile phone especially capable of direct connecting with a circuit board of a mobile phone to simplify the procedure of assembling, the module is provided with a base plate with a suitable area, the base plate has on a surface thereof a first micro-strip section and second micro-strip section being in relation with wavelengths of corresponding operation frequencies. The front ends of the micro-strip sections make an open circuit, the tailing ends of them are connected to be used as a third micro-strip section of a feed line. The second micro-strip section connected with the tailing end of the first micro-strip section forms an open stub for adjusting frequency width and impedance matching. The present invention is characterized in that: the feed line is connected with the micro-strips of a related circuit and the grounding line to form the antenna module with a coplanar wave guide effect.

### BACKGROUND OF THE INVENTION

1. Field of the Invention

The present invention is related to a hidden planar antenna module for a mobile phone, and especially to an antenna module capable of direct connecting with a circuit board of a mobile phone to simplify the procedure of assembling of the antenna for the mobile phone.

2. Description of the Prior Art

Earlier mobile phones used exposed helix antennas, such helix antennas can get different harmonic frequencies through different structural designs, however, they have the defect that an exposed helix antenna on the top of a mobile phone occupies a larger volume, they are hard for use on the miniature mobile phones available nowadays.

By virtue that a microstrip antenna has the advantages of being planar, miniaturized and capable of being built-in and hidden in a mobile phone, modern mobile phones mostly use microstrip antennas. But the microstrip antennas of the mobile phones available nowadays are generally provided in their housings in the form of lying down structures; mobile phones of some brands (such as NOKIA) must leave spaces in their housings above screens thereof for placing related antenna elements, in this view, a mobile phone is unable to have its length and volume further reduced.

There has been a conventional hidden planar antenna provided on the top of a mobile phone to effectively reduce the occupied volume of such a planar microstrip antenna in the housing of the mobile phone on one hand, and to increase the functions of receiving and emitting signals on the other hand by the fact that the antenna is provided on the top of the mobile phone. However, it is deficient in that its feed line must be welded to a circuit board of the mobile phone at a fixed spot; this makes trouble and inconvenience in assembling in site.

### SUMMARY OF THE INVENTION

The object of the present invention is to provide a hidden planar antenna module for a mobile phone, the module can be directly connected to a circuit board of the mobile phone to simplify the procedure of assembling-of the antenna for the mobile phone.

To get the above object, the present invention is provided with a base plate with a suitable area, the base plate has on a surface thereof a first micro-strip section and second micro-strip section being in relation with wavelengths of corresponding operation frequencies. The front ends of the micro-strip sections are in the state of an open circuit, the tailing ends of them are connected to be used as a third micro-strip section of a feed line. The second micro-strip section connected with the tailing end of the first micro-strip section forms an open stub for adjusting frequency width and impedance matching. The present invention is characterized by that: the feed line is connected with the micro-strips of a related circuit and the grounding line to form an antenna module with a coplanar wave guide effect.

In a preferred embodiment, all the micro-strips of the antenna module are made as a flexible printed circuit (FPC)

The present invention will be apparent in its novelty and other characteristics after reading the detailed description of the preferred embodiment thereof in reference to the accompanying drawings.

### BRIEF DESCRIPTION OF THE DRAWINGS

FIG. 1 is plane view showing the structure of the preferred embodiment of the present invention.

### DETAILED DESCRIPTION OF THE PREFERRED EMBODIMENT

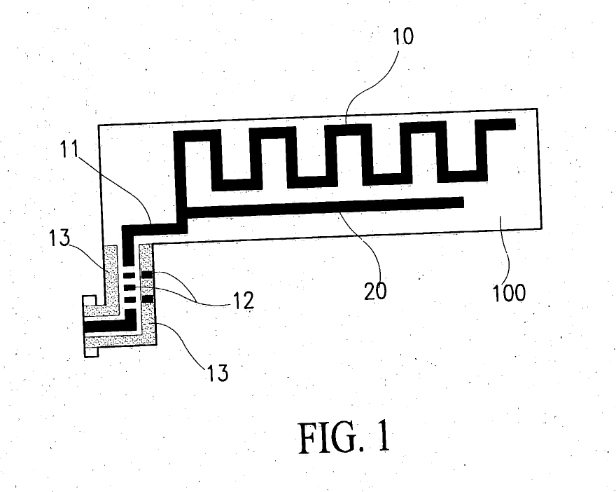

Referring to FIG. 1, the present invention is provided with a base plate 100 with a suitable area, the base plate 100 has on a surface thereof a first micro-strip section 10 and second micro-strip section 20. In this embodiment using two frequencies, the first micro-strip section 10 has a length of ¼ λ of the band section with 900 MHZ, the second micro-strip section 20 has a length of ¼ λ of the band section with 1800 MHZ. The front ends of the micro-strip sections 10, 20 make an open circuit, the tailing ends of them are connected to be used as a third micro-strip section of a feed line 11. The second micro-strip section 20 connected with the tailing end of the first micro-strip section 10 forms an open stub for adjusting frequency width and impedance matching.

The present invention is characterized in that: the feed line 11 is connected with a matched circuit 12 to complete the antenna module. In the preferred embodiment depicted, all the micro-strips of the matched circuit 12 connected with the feed line 11 and functioning as a signal line as well as of the related grounding line are enveloped with flexible soft plates. That is, they are made as a flexible printed circuit (FPC).

Although the feed line 11 in the above stated embodiment is disclosed to connect with the matched circuit, in practicable embodiments, it can also connect with an amplifying circuit.

The present invention of the above stated structure can be more conveniently and faster connected with a circuit board of a mobile phone in assembling in site by providing the antenna module. Thereby, the procedure of assembling in factories of such planar micro-strip antennas with mobile phones can be largely simplified.

Meantime, outward feeding of the abovementioned antenna module and the entire antenna form an effect of coplanar wave guide (CPW); the length of the radiating member counted as ¼ λ of the band section with 1800 MHZ can even be as large as ¼ λ of the band section with 1990 MHZ, hence the member has an effect of a wideband.

The preferred embodiment disclosed above is only for illustrating but not for limiting the present invention. It will be apparent to those skilled in this art that various modifications or changes made without departing from the spirit of this invention shall fall within the scope of the appended claims.

1. A hidden planar antenna module for a mobile phone, said module is provided with a base plate having a predetermined area, said base plate has on a surface thereof a first micro-strip section and a second micro-strip section being in relation with wavelengths of corresponding operation frequencies; the front ends of said micro-strip sections make an open circuit, the tailing ends of said micro-strip sections are connected to be used as a third micro-strip section of a feed line; said second micro-strip section connected with said tailing end of said first micro-strip section forms an open stub for adjusting frequency width and impedance matching; said module is characterized by that: said feed line is connected with micro-strips of a related circuit and a grounding line to form said antenna module with a coplanar wave guide effect.

2. The hidden planar antenna module for a mobile phone as defined in claim 1, wherein all said micro-strips of said antenna module are made as a flexible printed circuit (FPC).

3. The hidden planar antenna module for a mobile phone as defined in claim 1, wherein said related circuit is a matched circuit.

4. The hidden planar antenna module for a mobile phone as defined in claim 1, wherein said related circuit is an amplifying circuit.
